(19) United States
(12) Patent Application Publication
(10) Pub. No.: US 2019/0140492 A1
(43) Pub. Date: May 9, 2019

(54) POWER TRANSMISSION DEVICE FOR CONTACTLESS POWER TRANSMISSION, AND METHOD FOR CONTACTLESS POWER TRANSMISSION

(71) Applicant: BALLUFF GmbH, Neuhausen (DE)

(72) Inventors: Matthias Beyer, Stuttgart (DE); Tobias Bayer, Neuhausen (DE); Fabian Kayser, Bremen (DE); Stephan Senn, Wernau (DE)

(21) Appl. No.: 16/005,827

(22) Filed: Jun. 12, 2018

Related U.S. Application Data
(63) Continuation of application No. PCT/EP2015/081056, filed on Dec. 22, 2015.

(51) Int. Cl. H02J 50/90; H02J 50/40; H02J 50/12; H02J 50/05; H01F 38/14; G08C 17/06; H04B 5/00

(52) U.S. Cl. CPC H02J 50/90; H02J 50/40; H02J 50/12; H02J 50/05; G08C 17/04; G08C 17/06; H04B 5/0037; H04B 5/0012; H04B 5/0075; H01F 38/14

(57) ABSTRACT

There is provided a power transmission device for contactless power transmission, comprising a transmitter device and a receiver device, wherein the transmitter device has a first transmitter with a first transmitting frequency and at least one second transmitter with a second transmitting frequency, the second transmitting frequency is different from the first transmitting frequency, and the first transmitter is galvanically separated from the second transmitter, wherein the first transmitter has a first axis of symmetry and the second transmitter has a second axis of symmetry, and the first axis of symmetry of the first transmitter and the second axis of symmetry of the second transmitter are at least approximately coincident in a transmitter axis of symmetry, and wherein the receiver device has a first receiver associated with the first transmitter and a second receiver associated with the second transmitter.

This application is a continuation of international application number PCT/EP2015/081056 filed on 22 Dec. 2015, which is incorporated herein by reference in its entirety and for all purposes.

### BACKGROUND OF THE INVENTION

The invention relates to a power transmission device for contactless power transmission.

### SUMMARY OF THE INVENTION

In accordance with an embodiment of the invention, a power transmission device is provided, with which a plurality of transmission circuits with galvanically separated sources can be realised and which is space saving.

In accordance with an embodiment of the invention for the power transmission device, a transmitter device and a receiver device are provided, wherein the transmitter device has a first transmitter with a first transmitting frequency and at least one second transmitter with a second transmitting frequency, the second transmitting frequency is different from the first transmitting frequency, and the first transmitter is galvanically separated from the second transmitter, wherein the first transmitter has a first axis of symmetry and the second transmitter has a second axis of symmetry, and the first axis of symmetry of the first transmitter and the second axis of symmetry of the second transmitter are at least approximately coincident in a transmitter axis of symmetry, and wherein the receiver device has a first receiver associated with the first transmitter and a second receiver associated with the second transmitter.

As a result of the provision in accordance with an embodiment of the invention, the transmitter device can be provided in a space-saving manner.

The first transmitter and the second transmitter have a common axis of symmetry, at least approximately. At least two transmission circuits can be realised by different transmitting frequencies.

Different voltages, such as 5 V and 24 V, can thus also be transmitted.

The first receiver and the second receiver are favorably galvanically separated, such that passive safety standards are observed and in particular the first transmitter cannot couple into the second receiver, and the second transmitter cannot couple into the first receiver.

It is very particularly advantageous if the first receiver has a first axis of symmetry and the second receiver has a second axis of symmetry, wherein the first axis of symmetry of the first receiver and the second axis of symmetry of the second receiver are at least approximately coincident in a receiver axis of symmetry. A space-saving structure can thus be provided.

It is very particularly advantageous if the transmitter axis of symmetry and the receiver axis of symmetry are at least approximately coincident. Power can thus be transmitted “coaxially” in a plurality of transmission circuits with galvanically separated sources. A space-saving structure is thus achieved. For example, power can thus also be transmitted in a plurality of transmission circuits from a transmitter device to a receiver device, wherein the receiver device rotates relative to the transmitter device. The transmitter axis of symmetry and the receiver axis of symmetry are coil winding axes, for example.

In one exemplary embodiment at least one of the receiver axis of symmetry and the transmitter axis of symmetry is an axis of rotation for rotation of the receiver device relative to the transmitter device. By way of the solution according to the invention, power can be transmitted in a plurality of transmission circuits which are galvanically separated, even in the event of a relative rotation.

It can be provided here that at least one third transmitter having a third resonance frequency that is different from the first resonance frequency and the second resonance frequency is provided, and a third axis of symmetry is provided, which is at least approximately coincident with the transmitter axis of symmetry (of the first transmitter and of the second transmitter), wherein the third transmitter is galvanically separated from the first transmitter and the second transmitter. For example, a third transmission circuit can thus be provided, with coaxial coupling-in.

It is favorable if a third receiver is provided, which is associated with the third transmitter, with a third axis of symmetry of the third receiver, which is at least approximately coincident with a receiver axis of symmetry, wherein the third receiver is galvanically separated from the first receiver and the second receiver. A third transmission circuit can thus be realised.

In one exemplary embodiment an actuator system is associated with a first transmitter-receiver combination of the transmitter device and receiver device, and at least one of a sensor system and data transmission system is associated with a second transmitter-receiver combination. With regard to an actuator system for example on a machine, high safety standards and in particular passive safety standards have to be observed. If, for example, a power feed in a transmission circuit for the actuator system of actuators is interrupted by a central switch, power must not be transmitted to the actuator system by way of another transmission circuit. In the case of the solution according to the invention with different transmitting frequencies, a “cross-transmission” of this kind is effectively prevented, wherein a space-saving structure can be realised by the common axes of symmetry. In particular, a power transmission can also be performed in a plurality of transmission circuits with units rotating relative to one another.

For example, the receiver device is coupled inductively, capacitively or inductively-capacitively to the transmitter device. A contactless power transmission can thus be achieved in an effective way.

In one exemplary embodiment, coils or resonant circuits of the transmitter device are arranged on a first core, and coils or resonant circuits of the receiver device are arranged on a second core. Common axes of symmetry can thus be realised in a simple manner, wherein the axes of symmetry are, in particular, winding axes of coils.

For example, at least one of the first core and the second core are/is formed as a cylinder core or pot core or U-core or E-core.

It can be provided here that the first core is inserted into an internal spaceformed in the second core, or the second core is inserted into an internal spaceformed in the first core. A structure that is space-saving in particular with regard to the axial dimensions can thus be realised. A relative rotation between the cores (and thus between the transmitter device and the receiver device) can be realised in a simple way.

In an exemplary embodiment that is favorable from a manufacturing viewpoint, the transmitter device and the receiver device are of identical construction.

An air gap is provided between the transmitter device and the receiver device, through which air gap power is transmitted contactlessly in a plurality of transmission circuits.

In principle, the transmitter axis of symmetry and the receiver axis of symmetry do not have to be exactly coaxial. It is sufficient in particular if an offset is provided between the transmitter axis of symmetry and a receiver axis of symmetry, which offset is at most half the diameter of that coil of the transmitter device or of the receiver device having the smallest diameter.

Power can thus be transmitted “coaxially” in a plurality of transmission circuits even more effectively.

It is very particularly advantageous if the first resonance frequency and the second resonance frequency are selected such that, in the case of a winding short circuit of a coil of the transmitter device or the receiver device, the resonance frequencies remain different, and/or such that sufficient insulation resistances for spacing the resonance frequencies are present by way of damping between resonant circuits of the transmitter device and the receiver device. A “cross-coupling-in” of the first transmitter at the second receiver and of the second transmitter at the first receiver can thus be prevented in an effective way.

In accordance with an embodiment of the invention, a method for contactless power transmission from a transmitter device to a receiver device is provided, in which a first transmitter transmits power contactlessly with a first transmitting frequency to a second receiver, and a second transmitter transmits power contactlessly with a second transmitting frequency to a second receiver, wherein the first transmitter and the second transmitter are galvanically separated, and the first receiver and the second receiver are galvanically separated, and wherein the first transmitting frequency and the second transmitting frequency are different, and in which a transmitter axis of symmetry of the first transmitter and of the second transmitter and a receiver axis of symmetry of the first receiver and of the second receiver are at least approximately coincident.

The method according to the invention has the advantages already explained in conjunction with the power transmission device according to the invention.

Advantageous embodiments of the method according to the invention have also already been explained in conjunction with the power transmission device according to the invention.

In particular, the receiver device rotates relative to the transmitter device with an axis of rotation which is at least approximately coincident with the transmitter axis of symmetry or the receiver axis of symmetry. By way of the solution according to the invention, power can be transmitted contactlessly through an air gap in a plurality of transmission circuits with systems rotating relative to one another.

The following description of preferred embodiments serves in conjunction with the drawings to explain the invention in greater detail.

### BRIEF DESCRIPTION OF THE DRAWINGS

FIG. 1 shows an equivalent circuit diagram for an exemplary embodiment of a power transmission device according to the invention;

FIG. 2 shows a schematic illustration of a transmitter device and a receiver device of a first exemplary embodiment of a power transmission device according to the invention;

FIG. 3 shows a view of the transmitter device according to FIG. 2 in the direction A;

FIG. 4 shows a schematic illustration of a transmitter device and a receiver device of a second exemplary embodiment;

FIG. 5 shows a view in the direction B according to FIG. 4;

FIG. 6 shows a schematic illustration of a transmitter device and a receiver device of a third exemplary embodiment of a power transmission device according to the invention;

FIG. 7 shows a view in the direction C according to FIG. 6;

FIG. 8 shows a schematic illustration of a transmitter device and a receiver device of a fourth exemplary embodiment of a power transmission device according to the invention;

FIG. 9 shows a sectional view according to FIG. 8;

FIG. 10 shows an equivalent circuit diagram for a further embodiment of a power transmission device according to the invention;

FIG. 11 shows a plan view of an exemplary embodiment of a capacitor system;

FIG. 12 shows a perspective view of the capacitor system according to FIG. 11; and

FIG. 13 shows a sectional view along the line 13-13 of the capacitor system according to FIG. 11.

### DETAILED DESCRIPTION

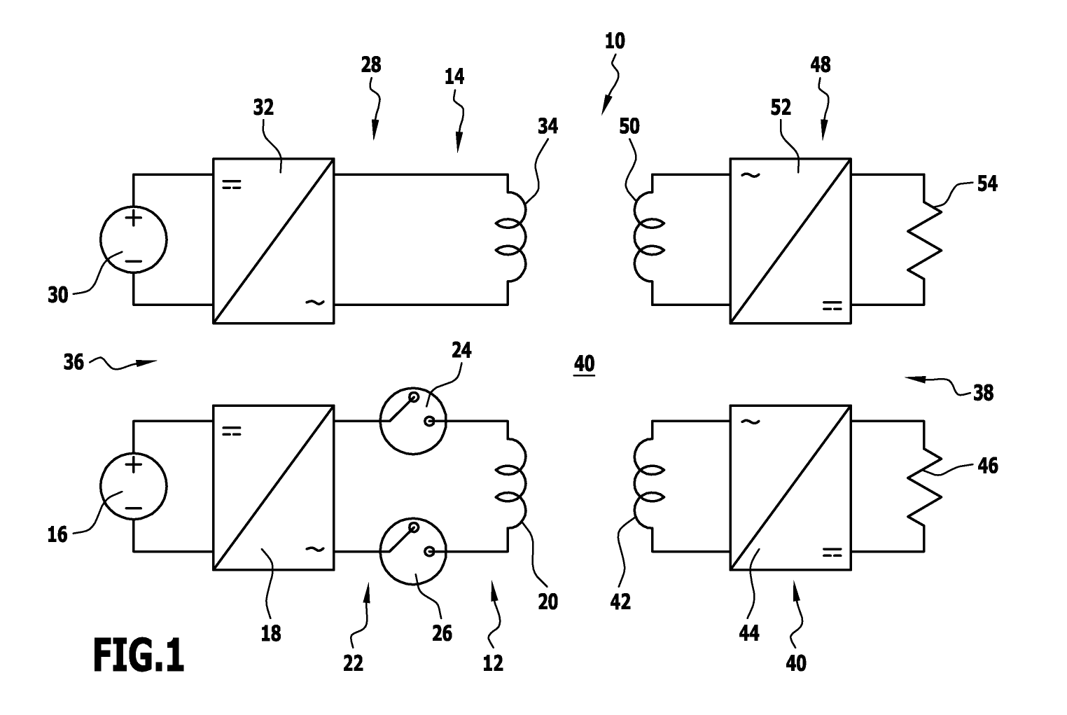

An exemplary embodiment of a power transmission device according to the invention which is shown in FIG. 1 in an equivalent circuit diagram and which is denoted there by 10 has a first transmission circuit 12 and a second transmission circuit 14, which is galvanically separated from the first transmission circuit 12.

The first transmission circuit 12 has a first source 16 for electrical power. This first source 16 is arranged upstream of a first converter 18. The first converter 18 converts a direct current into an alternating current. The first source 16 and the first converter 18 form a first alternating current source in combination.

A first coil 20 is connected to this first alternating current source. A first transmitter 22 with a resonant circuit is thus formed. (Capacitors of the resonant circuit are not shown in FIG. 1).

A first switch 24 and a second switch 26 are arranged on the first transmitter 22, by way of which switches the current feed to the first coil 20 can be interrupted. A safety function can thus be provided.

In FIG. 1 the switches 24 and 26 are shown as lying between the first converter 18 and the first coil 20. It is also possible that the switches 24, 26 are positioned between the first source 16 and the first converter 18. It is also possible that the first switch 24 and the second switch 26 are arranged within the first converter 18.

It is also possible that one switch 24 or 26 is arranged on the source side (between the first source 16 and the first converter 18) and the other switch 26 or 24 is arranged on the coil side between the converter 18 and the first coil 20.

It is also possible that one switch is arranged on the first converter 18 and the other switch is arranged on the source side or the coil side.

The second transmission circuit 14 has a second transmitter 28. The second transmitter 28 comprises a second source 30. The second source 30 is galvanically separated from the first source 16. The second source 30 is arranged upstream of a second converter 32. The second source 30 forms a second alternating current source in combination with the second converter 30. A second coil 34 is connected to said second alternating current source.

A second resonant circuit is thus formed. (Capacitors in the resonant circuit in FIG. 1 are not shown explicitly).

The first transmitter 22 and the second transmitter 28 form a transmitter device 36.

The power transmission device 10 also comprises a receiver device 38. The receiver device 28 is separated from the transmitter device 36 by way of an air gap 40.

The receiver device 38 has a first receiver 40, which is associated with the first transmitter 22.

The first receiver 40 has a first coil 42, by way of which a resonant circuit is formed. The first coil 20 of the first transmitter 22 couples inductively to the first coil 42 of the first receiver 40. (Resonant circuit capacitors of the first receiver 40 are not shown in FIG. 1).

The first coil 42 is arranged upstream of a first converter 44, which converts alternating currents into direct currents.

One or more loads 46 is/are connected to the first converter 44.

The receiver device 38 also has a second receiver 48. This second receiver 48 is associated with the second transmitter 28.

The second receiver 48 has a second coil 50. A resonant circuit is formed by way of this second coil. (Capacitors of the resonant circuit are not shown in FIG. 1).

The second coil 50 is arranged upstream of a second converter 52, which converts alternating currents into direct currents.

One or more loads 54 is/are connected to the second converter 52.

The first transmitter 22 transmits power contactlessly to the first receiver 40. The second transmitter 28 transmits power contactlessly to the second receiver 48.

The first receiver 40 and the second receiver 48 are galvanically separated, similarly to the first transmitter 22 and the second transmitter 28.

The first transmitter 22 is operated with a first transmitting frequency. The first transmitting frequency is in particular a resonance frequency or a frequency in a resonance range of the resonant circuit of the first transmitter 22. The first receiver 40 is also set to this transmitting frequency.

The second transmitter 28 is operated with a second transmitting frequency, which is different from the first transmitting frequency. The second transmitting frequency is in particular a resonance frequency or lies in a resonance frequency range of the resonant circuit of the second transmitter 28.

The second receiver 48 is set to the second transmitting frequency.

The first transmitting frequency and the second transmitting frequency are selected such that the power from galvanically separated sources, namely the first source 16 and the second source 30, is transmitted to two transmission circuits, namely the first transmission circuit 12 and the second transmission circuit 14.

There is both a primary-side galvanic separation at the transmitter device 36 and a secondary-side galvanic separation at the receiver device.

The resonance frequencies are selected such that, by way of a winding short circuit of the first coil 20 or of the second coil 50, by ageing of capacitors, etc., a convergence of the transmitting frequencies is ruled out or the damping does not fall below a certain limit. The transmitting frequencies are also selected such that, by way of the damping between the resonant circuits, correspondingly high insulation resistances are maintained, so as to ensure passive electrical safety. The transmitter device 36 and the receiver device 38 are formed such that, even in the event of faults including coil breakage, the first transmitter 22 does not couple into the second receiver 48 and the second transmitter 28 does not couple into the first receiver 40.

The first transmission circuit 12 is used for example to transmit power to actuators and for example actuators of a machine. The one or more loads 46 is/are then actuators. It is possible here to disconnect the actuators (the one or more loads 46) by way of a central safety device. To this end, the first switch 24 and the second switch 26 are provided.

The second transmission circuit 14 is used for example for data transmission or power transmission to a sensor system for example of a machine. The loads 54 are then sensors, for example.

By way of the galvanic separation of the first transmission circuit 12 and of the second transmission circuit 14, a passive safety measure can be provided. It can be ensured that, for example, the second transmission circuit 14 does not couple into the first transmission circuit 12 if the first transmission circuit 12 is disconnected by way of the first switch 24 or the second switch 26.

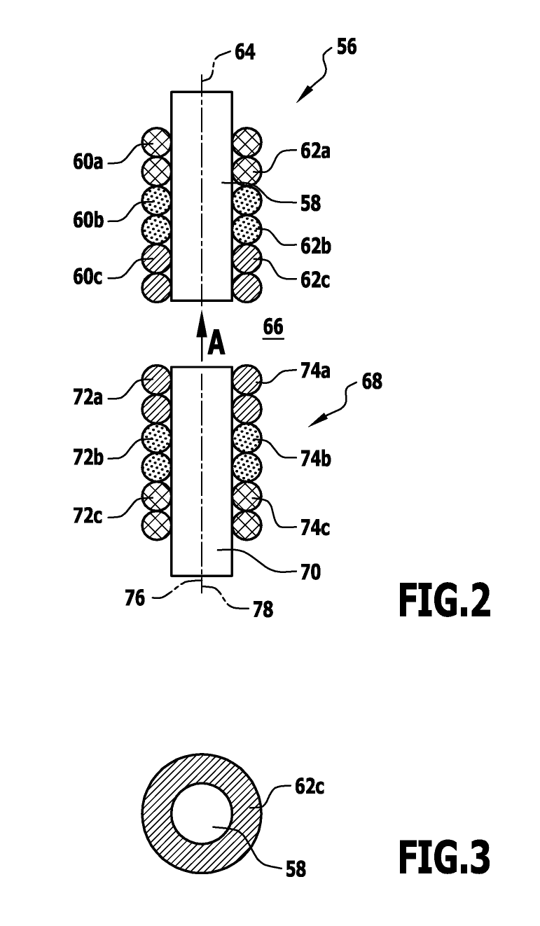

It is provided in accordance with the invention that the transmission device 36 and the receiver device 38 are arranged coaxially (FIGS. 2 to 9).

In a first exemplary embodiment (FIGS. 2 and 3), a transmitter device 56 is provided, which has a first core 58, which for example is cylindrical. In the shown exemplary embodiment a first transmitter 60a, a second transmitter 60b, and a third transmitter 60c are arranged at least in part on the first core 58. The first transmitter 60a, the second transmitter 60b, and the third transmitter 60c are formed by respective resonant circuits with a first coil 62a, a second coil 62b, and a third coil 62c respectively.

The coils 62a, 62b, 62c are arranged successively on the first core 58. They have a common winding axis 64, which is a cylinder axis of the first core 58. The winding axis 64 is an axis of symmetry for the coils 62a, 62b, 62c.

This winding axis 64 forms a transmitter axis of symmetry, which is common to the first transmitter 60a, the second transmitter 60b, and the third transmitter 60c.

A receiver device 68 associated with the transmitter device 56 and spaced therefrom by an air gap 66 has a second core 70. A first receiver 72a, a second receiver 72b, and a third receiver 72c sit on this second core 70. These receivers each have resonant circuits with coils 74a, 74b, 74c. These are arranged in succession on the second core 70.

The coils 74a, 74b, 74c of the receivers 72a, 72b, 72c have a common winding axis 76, which forms the axis of symmetry of each of the coils 74a, 74b 74c. This is formed coaxially with a cylinder axis of the second core 70, which is cylindrical.

The winding axis 76 forms a receiver axis of symmetry of the receiver device 68.

The transmitter axis of symmetry 64 and the receiver axis of symmetry 76 are coaxial with one another.

The first transmitter 60a, the second transmitter 60b, and the third transmitter 60c are galvanically separated from one another. They each have a first transmitting frequency, a second transmitting frequency, and a third transmitting frequency, which are different.

The first receiver 72a is coordinated with the first transmitter 60a, the second receiver 72b is coordinated with the second transmitter 60b, and the third receiver 72c is coordinated with the third transmitter 60c.

Electrical power can be transmitted axially parallel to the receiver device 68 by way of three different transmitters 60a, 60b, 60c with galvanic separation of the corresponding sources for these transmitters 60a, 60b, 60c. For example, a rotation of the receiver device 68 about an axis of rotation 78 relative to the transmitter device 56 is thus possible. The receiver device 68 can be configured for example in a mobile manner, at least with respect to the second core 70 with the parts of the first receiver 72a, the second receiver 72b, and the third receiver 72c arranged thereon.

The transmitter device 56 can also have just two transmitters or more than three transmitters, wherein the receiver device 78 is then formed in a manner coordinated therewith.

In the exemplary embodiment according to FIGS. 2 and 3, two galvanically separated transmission circuits (corresponding to the transmission circuits 12 and 14) can be realised, wherein, by use of different resonance frequencies, an axis-parallel arrangement is possible and in particular also a relative rotation about the axis of rotation 78 between the receiver device 68 and the transmitter device 56 is possible.

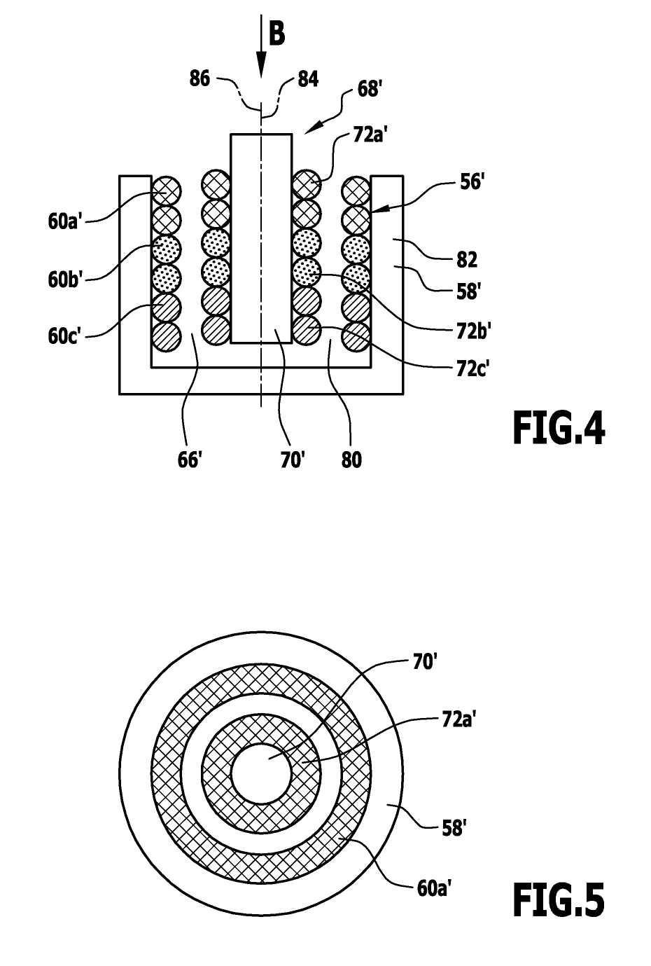

In a further exemplary embodiment, which is shown schematically in FIGS. 4 and 5, a transmitter device 56′ is provided. This comprises a first transmitter 60a′, a second transmitter 60b′, and a third transmitter 60c′. These are arranged on a core 58′, which has a pot shape.

The core 58′ here has an internal space 80, wherein corresponding coils of the transmitters 60a′, 60b′, 60c′ are arranged in succession on an inner side of an outer wall 82.

The coils of the transmitters 60a′, 60b′, 60c′ have a winding axis 84. This winding axis 84 is coincident with an axis of symmetry of the wall 82, which in particular has the form of a cylinder ring. The winding axis 84 defines a transmitter axis of symmetry.

A receiver device 68′ has a second core 70′. This is cylindrical. Corresponding receivers 72a′, 72b′ and 72c′ sit on said core and are associated with the respective transmitters 60a′, 60b′, 60c′.

The transmitters 60a′, 60b′, 60c′ each have different transmitting frequencies, and the receivers 72a′, 72b′, 72c′ are coordinated therewith.

Coils of the receivers 72a′, 72b′, 72c′ have a winding axis 86. This winding axis is common for the receivers 72a′, 72b′, 72c′, and is coincident with a cylinder axis of the second core 70′. This winding axis 86 defines a receiver axis of symmetry.

The winding axis 84 and the winding axis 86 are coaxial, that is to say the transmitter axis of symmetry and the receiver axis of symmetry are coincident.

The coils of the receiver device 68′ are spaced here from the coils of the transmitter device 56′ by an air gap 66′ formed in the internal space 80.

The second core 70′ can rotate for example about an axis of rotation parallel to the transmitter axis of symmetry or receiver axis of symmetry in the internal space 80 relative to the wall 82 and thus the transmitter device 56′. Power can thus be transmitted to the receiver device 68′ coaxially, even with galvanically separated sources for the transmitters 60a′, 60b′, 60c′.

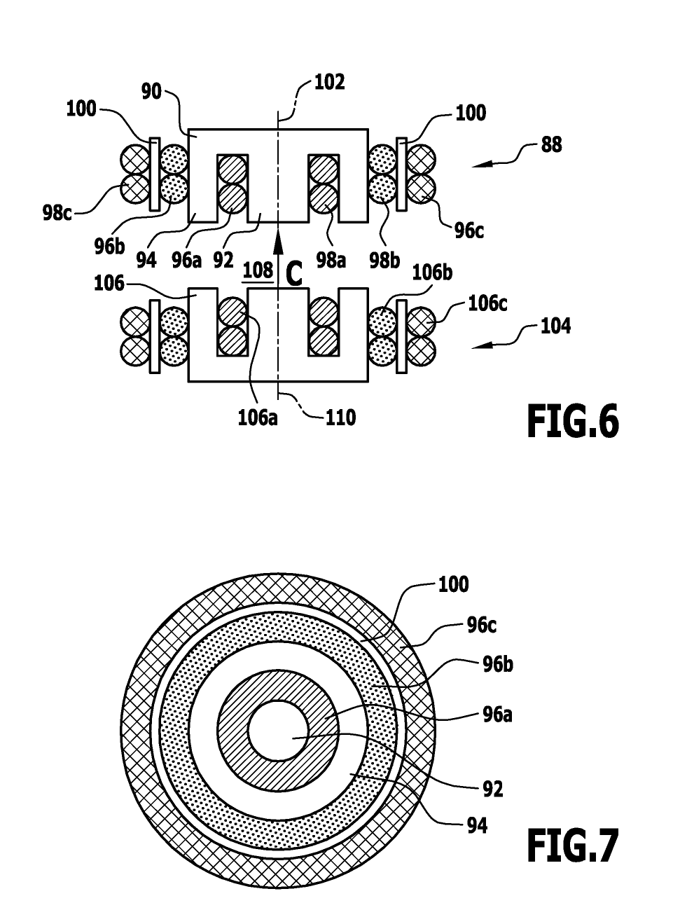

In a third exemplary embodiment (FIGS. 6 and 7), a transmitter device 88 is provided, which has a pot core 90 with a central hub 92. An annular space is formed between the hub 92 and a wall 94 of the pot core 90. A first coil 96a of a first transmitter 98a of the transmitter device 88 sits in this annular space.

A second coil 96b of a second transmitter 98b sits on an outer side of the wall 94.

A separation element, such as at least one of a ferrite ring 100 and a ferrite film, sits on the second coil 96b. A third coil 96c of a third transmitter 98c sits on the ferrite ring 100.

The first coil 96a, the second coil 96b, and the third coil 96c are coils of a resonant circuit. They have a common winding axis 102, which is a transmitter axis of symmetry. This winding axis 102 is coincident with an axis of symmetry of the hub 92 and also of the wall 94.

The transmitter device 88 is associated with a receiver device 104. This receiver device 104 likewise has a pot core 106 as second core. Coils of a first receiver 106a, a second receiver 106b, and a third receiver 106c are arranged on this pot core. These coils are arranged here in the same way as the corresponding coils 98a, 98b, 98c of the transmitter device 88.

An air gap 108 lies between the transmitter device 88 and the receiver device 104.

The coils of the receiver device 104 have a common winding axis 110. This forms a receiver axis of symmetry.

The winding axes 110 and 102 lie coaxially with one another. The transmitter axis of symmetry and the receiver axis of symmetry thus lie coaxially with one another accordingly.

It is possible to transmit power contactlessly from the transmitter device 88 to the receiver device 104 in different transmission circuits with galvanically separated sources correspondingly.

The first transmitter 98a, the second transmitter 98b, and the third transmitter 98c have different transmitting frequencies here.

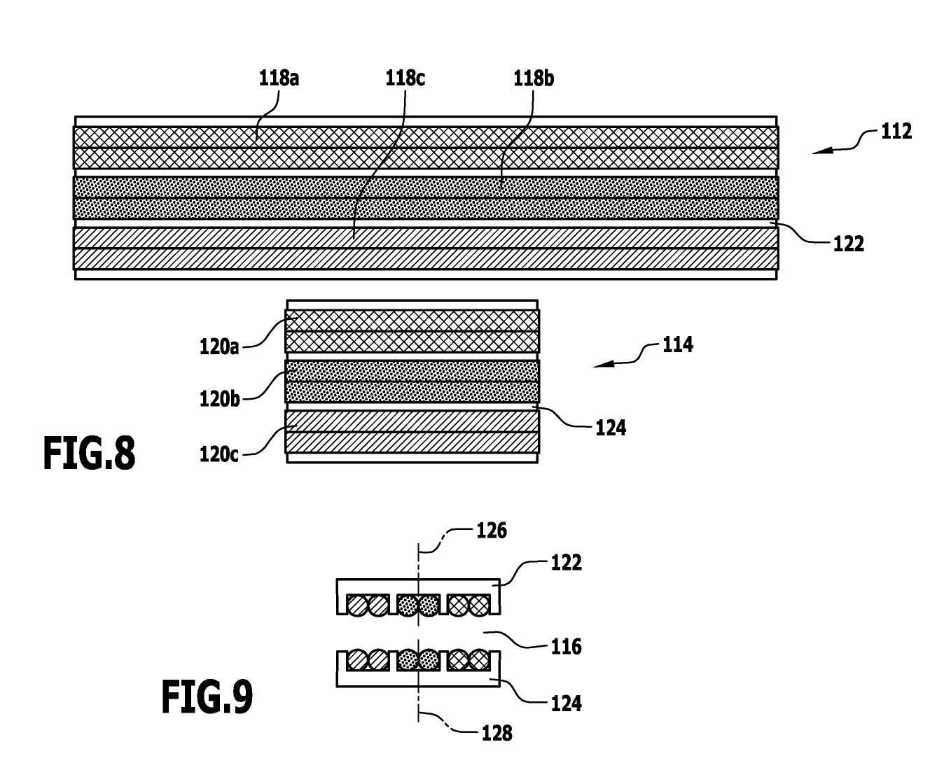

In a further exemplary embodiment, which is shown schematically in FIGS. 8 and 9, a transmitter device 112 and a receiver device 114 are provided. An air gap 116 lies therebetween (see FIG. 9). Coils 118a, 118b, 118c of transmitters of the transmitter device 112 are arranged on the transmitter device 112. Corresponding sources are galvanically separated.

Coils 120a, 120b, 120c of corresponding receivers are provided on the receiver device 114.

The coils 118a, 118b, 118c are for example arranged on a concatenation of a plurality of U-cores or E-cores 122. The coils 120a, 120b, 120c of the receiver device 114 are arranged on such cores 124 accordingly.

The transmitter device 112 has a transmitter axis of symmetry 126, and the receiver device 114 has a receiver axis of symmetry 128.

The transmitter axis of symmetry 126 and the receiver axis of symmetry 128 are coaxial with one another.

The exemplary embodiments according to FIGS. 2 to 9 have, as equivalent circuit diagram, the equivalent circuit diagram 10 according to FIG. 1, wherein, in the shown exemplary embodiments according to FIGS. 2 to 9, a third transmission circuit is also provided. By way of the solution according to the invention, power can be transmitted coaxially in separate transmission circuits with galvanically separated sources, wherein corresponding transmitters have different transmitting frequencies. Passive safety requirements are thus observed, wherein a contactless power transmission is possible for example even in the case of rotating systems.

In the described exemplary embodiments the power is transmitted inductively between the appropriate transmission device 36 and the receiver device 38.

A divergence of axes of symmetry from the coaxial arrangement is also possible here, wherein this deviation is then at most half the diameter of that coil of the transmitter device 36 or of the receiver device 39 having the smallest diameter.

It is also possible in principle to provide a capacitive or inductive-capacitive contactless power transmission with different transmission circuits by way of the solution according to the invention.

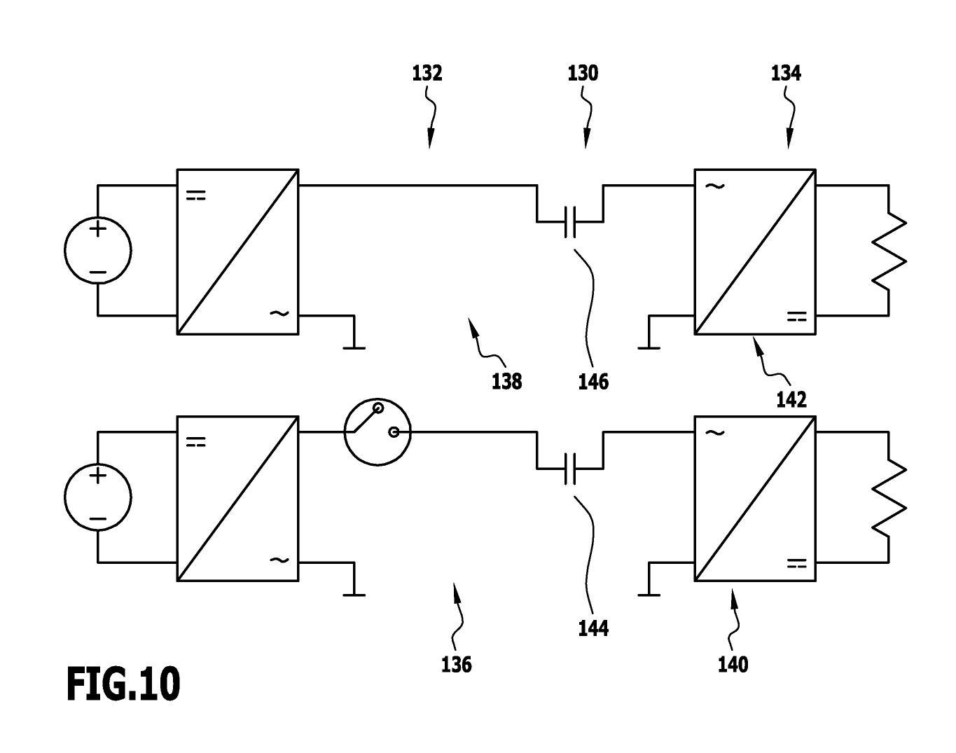

FIG. 10 shows an equivalent circuit diagram 130 for a further exemplary embodiment, in which the contactless power transmission between a transmitter device 132 and a receiver device 134 is performed capacitively. The transmitter device 132 has a first transmitter 136 and a second transmitter 138. The first transmitter 136 and the second transmitter 138 have separate galvanic sources.

The receiver device 134 has a first receiver 140 and a second receiver 142. The first receiver 140 is associated with the first transmitter 136, and the second receiver 142 is associated with the second transmitter 138.

The first transmitter 136 couples to the first receiver 140 by way of a first capacitive device 144. The second receiver 142 couples to the second transmitter 138 by way of a second capacitive device 146.

The first capacitive device 144 and the second capacitive device 146 have a common axis of symmetry, such that the coupling is coaxial.

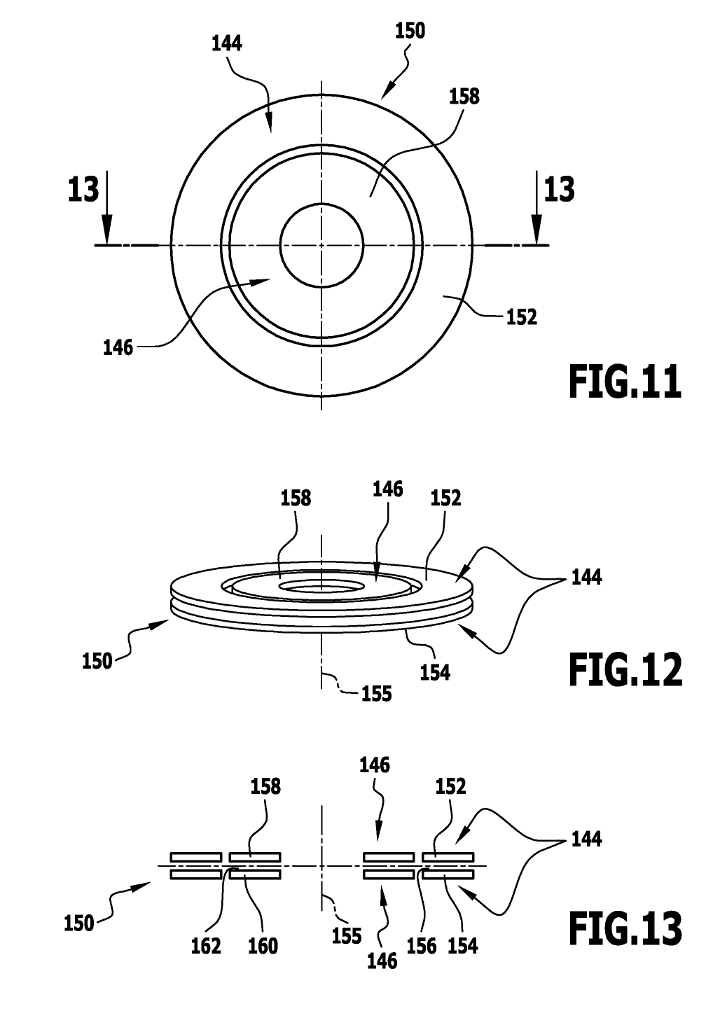

An exemplary embodiment of a capacitor device, which is shown in FIGS. 11 to 13, comprises the first capacitive device 144 and the second capacitive device 146.

The first capacitive device 144 has a first ring disc 152 and a second ring disc 154. The first ring disc 152 and the second ring disc 154 are formed to be substantially the same. They are coaxial with an axis of symmetry 155, which is also a spacer axis between the first ring disc 152 and the second ring disc 154.

An annular air gap 156 lies between the first ring disc 152 and the second ring disc 154 of the first capacitive device 144.

The second capacitive device 146 has a first ring disc 158 and a second ring disc 160. The first ring disc 158 and the second ring disc 160 are arranged coaxially with the axis of symmetry 155 and are formed to be the same. They are spaced apart in the axis of symmetry 155, wherein the spacing is the same as the spacing between the first ring disc 152 and the second ring disc 154 of the first capacitive device 144. An air gap 162 lies between the ring discs 158, 160 of the second capacitive device 146, which air gap has the same height as the air gap 156 based on the axis of symmetry 155.

The first ring disc 158 and the second ring disc 160 of the second capacitive device 146 have the same height as the first ring disc 152 and the second ring disc 154 of the first capacitive device 144 (i.e., they have the same thickness in the direction of the axis of symmetry 155).

The first ring disc 152 of the first capacitive device 144 and the first ring disc 158 of the second capacitive device 146 are also each arranged in an aligned manner in respect of an upper side and a lower side.

The second ring disc 154 of the first capacitive device 144 and the second ring disc 160 of the second capacitive device 146 are also each arranged flush with an upper side and a lower side.

The first ring disc 152 of the first capacitive device 144 surrounds the first ring disc 158 of the second capacitive device 146 completely, that is to say the first ring disc 158 of the second capacitive device 146 is arranged in an annular space of the first ring disc 152 at a spacing from the first ring disc 152 of the first capacitive device 144.

In the same way, the second ring disc 144 of the first capacitive device 144 surrounds the second ring disc 160 of the second capacitive device 146 completely.

The axis of symmetry 155 forms a transmitter axis of symmetry, which is coincident with a corresponding receiver axis of symmetry.

The ring discs 152, 154, 158, 160 form capacitor plates.

In the case of a capacitive coupling, the ring disc 152 of the first capacitive device 144 can be considered to be a first transmitter. The first ring disc 158 of the second capacitive device 146 can be considered to be a second transmitter. The second ring disc 154 can be considered to be a first receiver. The second ring disc 160 of the second capacitive device 146 can be considered to be a second receiver.

The axes of symmetry of the first transmitter and of the second transmitter are coincident. This coincident axis of symmetry also forms the receiver axis of symmetry. (In an alternative consideration, the combination of first ring disc 152 and second ring disc 154 of the first capacitive device 144 can be considered as first transmitter and as first receiver, and the combination of the first ring disc 158 and of the second ring disc 160 of the second capacitive device 146 can be considered as second transmitter and second receiver.)

### LIST OF REFERENCE NUMERALS

10 equivalent circuit diagram of the power transmission device
12 first transmission circuit
14 second transmission circuit
16 first source
18 first converter
20 first coil
22 first transmitter
24 first switch
26 second switch
28 second transmitter
30 second source
32 second converter
34 second coil
36 transmitter device
38 receiver device
40 first receiver
42 first coil
44 first converter
46 load
48 second receiver
50 second coil
52 second converter
54 load
56, 56′ transmitter device
58, 58′ first core
60a, 60a′ first transmitter
60b, 60b′ second transmitter
60c, 60c′ third transmitter
62a first coil
62b second coil
62c third coil
64 winding axis
66, 66′ air gap
68, 68′ receiver device
70, 70; second core
72a, 72a′ first receiver
72b, 72b′ second receiver
72c, 72c′ third receiver
74a coil
74b coil
74c coil
76 winding axis
78 axis of rotation
80 internal space
82 wall
84 winding axis
86 winding axis
88 transmitter device
90 pot core
92 hub
94 wall
96a first coil
96b second coil
96c third coil
98a first transmitter
98b second transmitter
98c third transmitter
100 ferrite ring
102 winding axis
104 receiver device
106a first receiver
106b second receiver
106c third receiver
108 air gap
110 winding axis
112 transmitter device
114 receiver device
116 air gap
118a coil
118b coil
118c coil
120a coil
120b coil
120c coil
122 core
124 core
126 transmitter axis of symmetry
128 receiver axis of symmetry
130 equivalent circuit diagram
132 transmitter device
134 receiver device
136 first transmitter
138 second transmitter
140 first receiver
142 second receiver
144 first capacitive device
146 second capacitive device
150 capacitor device
152 first ring disc
154 second ring disc
155 axis of symmetry
156 air gap
158 first ring disc
160 second ring disc
162 air gap

What is claimed is:

1. A power transmission device for contactless power transmission, comprising:
a transmitter device; and
a receiver device;
wherein the transmitter device has a first transmitter with a first transmitting frequency and at least one second transmitter with a second transmitting frequency;
wherein the second transmitting frequency is different from the first transmitting frequency;
wherein the first transmitter is galvanically separated from the second transmitter;
wherein the first transmitter has a first axis of symmetry and the second transmitter has a second axis of symmetry;
wherein the first axis of symmetry of the first transmitter and the second axis of symmetry of the second transmitter are at least approximately coincident in a transmitter axis of symmetry; and
wherein the receiver device has a first receiver associated with the first transmitter and a second receiver associated with the second transmitter.

2. A power transmission device according to claim 1, wherein the first receiver and the second receiver are galvanically separated.

3. A power transmission device according to claim 1, wherein the first receiver has a first axis of symmetry and the second receiver has a second axis of symmetry, wherein the first axis of symmetry of the first receiver and the second axis of symmetry of the second receiver are at least approximately coincident in a receiver axis of symmetry.

4. A power transmission device according to claim 3, wherein the transmitter axis of symmetry and the receiver axis of symmetry are at least approximately coincident.

5. A power transmission device according to claim 3, wherein at least one of the receiver axis of symmetry and the transmitter axis of symmetry is an axis of rotation for rotation of the receiver device relative to the transmitter device.

6. A power transmission device according to claim 1, further comprising at least one third transmitter with a third resonance frequency, which is different from the first resonance frequency and the second resonance frequency, and with a third axis of symmetry, which is at least approximately coincident with the transmitter axis of symmetry, wherein the third transmitter is galvanically separated from the first transmitter and the second transmitter.

7. A power transmission device according to claim 6, further comprising a third receiver, which is associated with the third transmitter, with a third axis of symmetry of the third receiver, which is at least approximately coincident with a receiver axis of symmetry, wherein the third receiver is galvanically separated from the first receiver and the second receiver.

8. A power transmission device according to claim 1, wherein an actuator system is associated with a first transmitter-receiver combination of the transmitter device and receiver device, and at least one of a sensor system and data transmission system is associated with a second transmitter-receiver combination.

9. A power transmission device according to claim 1, wherein the receiver device is coupled inductively, capacitively or inductively-capacitively to the transmitter device.

10. A power transmission device according to claim 1, wherein coils or resonant circuits of the transmitter device are arranged on a first core and coils or resonant circuits of the receiver device are arranged on a second core.

11. A power transmission device according to claim 10, wherein at least one of the first core and the second core is formed as a cylinder core or pot core or U-core or E-core.

12. A power transmission device according to claim 10, wherein the first core is inserted into an internal spaceformed in the second core, or the second core is inserted into an internal spaceformed in the first core.

13. A power transmission device according to claim 1, wherein the transmitter device and the receiver device are of identical construction.

14. A power transmission device according to claim 1, wherein there is an air gap between the transmitter device and the receiver device.

15. A power transmission device according to claim 1, wherein an offset between the transmitter axis of symmetry and a receiver axis of symmetry is at most half the diameter of that coil of the transmitter device or of the receiver device having the smallest diameter.

16. A power transmission device according to claim 1, wherein the first resonance frequency and the second resonance frequency are selected such that, at least one of (i) in the event of a winding short circuit of a coil of the transmitter device or receiver device, the resonance frequencies remain different, and (ii) by way of damping between resonant circuits of the transmitter device and the receiver device there are provided sufficient insulation resistances for a spacing of the resonance frequencies.

17. A method for contactless power transmission from a transmitter device to a receiver device, comprising:
transmitting power by a first transmitter contactlessly with a first transmitting frequency to a first receiver; and
transmitting power by a second transmitter contactlessly with a second transmitting frequency to a second receiver;
wherein the first transmitter and the second transmitter are galvanically separated;
wherein the first receiver and the second receiver are galvanically separated;
wherein the first transmitting frequency and the second transmitting frequency are different; and
wherein a transmitter axis of symmetry of the first transmitter and of the second transmitter and a receiver axis of symmetry of the first receiver and of the second receiver are at least approximately coincident.

18. A method according to claim 17, wherein the receiver device rotates relative to the transmitter device with an axis of rotation which is at least approximately coincident with the transmitter axis of symmetry or the receiver axis of symmetry.
